(19) United States
(12) Patent Application Publication
(10) Pub. No.: US 2020/0272961 A1
(43) Pub. Date: Aug. 27, 2020

(54) INFORMATION PROCESSING APPARATUS, INFORMATION PROCESSING METHOD, AND STORAGE MEDIUM

(71) Applicant: LINK AND MOTIVATION INC., Tokyo (JP)

(72) Inventors: Yoshihisa OZASA, Tokyo (JP); Hideki SAKASHITA, Tokyo (JP)

(73) Assignee: LINK AND MOTIVATION INC., Tokyo (JP)

(21) Appl. No.: 16/646,488

(22) PCT Filed: Sep. 7, 2018
(86) PCT No.: PCT/JP2018/033189

§ 371 Date: Mar. 11, 2020

(30) Foreign Application Priority Data
Sep. 19, 2017 (JP) 2017-178480

(51) Int. Cl. G06Q 10/06

(52) U.S. Cl. CPC G06Q 10/0631

(57) ABSTRACT

In order to address a conventional problem that it is difficult to understand important items from the viewpoint of an organization, an information processing apparatus in which two or more pieces of organization response information are stored, the information containing, for each of two or more members belonging to the organizations, two or more pieces of item response information having an item identifier for identifying an item regarding an organization, and response information containing satisfaction level information of a member to the item, includes: an item score acquiring unit that performs statistical processing on the response information of the members to the two or more items contained in the two or more pieces of organization response information, thereby acquiring an item score for each organization and for each item; an overall score acquiring unit that acquires an overall score for each organization, using the two or more item scores from the two or more pieces of organization response information; an influence level acquiring unit that acquires, for each item, an level of influence of the item on overall scores using the two or more item scores and the two or more overall scores; and an influence level output unit that outputs the level of influence in association with each item. Accordingly, it is possible to understand important items with ease from the viewpoint of an organization.

### TECHNICAL FIELD

The present invention relates to an information processing apparatus and the like for acquiring and outputting the level of influence of two or more items on an organization overall score calculated from responses to the items.

### BACKGROUND ART

Conventionally there are systems capable of providing an individual belonging to a group, with advice for actions for improving a state of the group or the individual (see Patent Document 1, for example).

### CITATION LIST

### Patent Document

Patent Document 1: Japanese Patent No. 5854988

### SUMMARY OF INVENTION

### Technical Problem

However, according to conventional techniques, it is difficult to understand important items from the viewpoint of an organization. More specifically, for example, it is difficult to properly understand important items in an engagement system for realizing engagement in which employees and an organization grow due to the employees trying to display their abilities on their own judgment in order to achieve a goal of the organization. In particular, it is not possible to quantitatively understand important items. Thus, it is difficult to understand proper improvement items, and sufficient improvement of organizations based on questionnaire results cannot be performed with ease.

### Solution to Problem

A first aspect of the present invention is directed to an information processing apparatus, including: an organization response information storage unit in which organization response information is stored for two or more organizations, the information containing, for each of two or more members belonging to the organizations, two or more pieces of item response information having an item identifier for identifying an item regarding an organization, and response information containing satisfaction level information, which is a response regarding a satisfaction level of a member to the item; an item score acquiring unit that performs statistical processing on the response information of the members to the two or more items contained in the two or more pieces of organization response information, thereby acquiring an item score, which is a score for an item, for each organization and for each item; an overall score acquiring unit that acquires an overall score, which is an overall score for each organization, using the two or more item scores from the two or more pieces of organization response information; an influence level acquiring unit that acquires, for each item, an level of influence of item scores of the item on overall scores, using the item scores of the two or more items of the two or more organizations and the overall scores of the two or more organization; and an influence level output unit that outputs the level of influence acquired by the influence level acquiring unit, in association with each item.

With this configuration, it is possible to understand important items with ease. In particular, it is possible to quantitatively understand important items.

Furthermore, a second aspect of the present invention is directed to the information processing apparatus according to the first aspect, wherein, for at least some of the items, the response information also contains expectation level information, which is a response regarding an expectation level of a member, and the item score acquiring unit acquires, for each organization, item scores of at least some of the items, using the satisfaction level information and the expectation level information.

With this configuration, it is possible to precisely understand important items with ease. In particular, it is possible to quantitatively and precisely understand important items.

Furthermore, a third aspect of the present invention is directed to the information processing apparatus according to the second aspect, wherein the overall score acquiring unit acquires a tentative overall score, which is a tentative overall score for each organization, using the two or more item scores from the two or more pieces of organization response information, acquires correlation information regarding a degree of correlation between the satisfaction level information and the expectation level information of each of the two or more items, for each of the two or more organizations, and acquires an overall score from the tentative overall score using the correlation information such that the larger the degree of correlation is, the larger the score is.

With this configuration, it is possible to precisely understand important items with ease. In particular, it is possible to quantitatively and precisely understand important items.

Furthermore, a fourth aspect of the present invention is directed to the information processing apparatus according to any one of the first to third aspects, wherein, for each of the two or more organizations, the item score acquiring unit calculates, for each of the two or more items, an average value of the satisfaction level information contained in the response information, or an average value of the satisfaction level information contained in the response information and an average value of the expectation level information contained in the response information, and acquires an item score for each item using the one or two average values.

With this configuration, it is possible to understand important items with ease. In particular, it is possible to quantitatively understand important items.

Furthermore, a fifth aspect of the present invention is directed to the information processing apparatus according to any one of the first to fourth aspects, wherein the two or more items have multiple overall items that are each an item for an overall object and multiple individual items that are each an item for an individual object of a company, and the overall score acquiring unit acquires an overall score, using both item scores of the overall items and item scores of the individual items while making weights of the item scores of the overall items greater than those of the item scores of the individual items.

With this configuration, it is possible to precisely understand important items with ease. In particular, it is possible to quantitatively and precisely understand important items.

Furthermore, a sixth aspect of the present invention is directed to the information processing apparatus according to any one of the first to fifth aspects, wherein the influence level acquiring unit calculates, for each item, a level of influence, which is information regarding correlation between item scores of the item and overall scores, using the overall scores of the two or more organizations and the item scores of the item of the two or more organizations.

With this configuration, it is possible to precisely understand important items with ease. In particular, it is possible to quantitatively and precisely understand important items.

Furthermore, a seventh aspect of the present invention is directed to the information processing apparatus according to any one of the first to fifth aspects, wherein the organization response information is associated with an attribute value of an organization, and the influence level acquiring unit acquires, for each item, an level of influence of item scores of the item on overall scores, for each attribute value of an organization.

With this configuration, it is possible to acquire a level of influence of each attribute value of an organization, and to precisely understand important items with ease. In particular, it is possible to quantitatively and precisely understand important items.

Furthermore, an eighth aspect of the present invention is directed to the information processing apparatus according to any one of the first to sixth aspects, wherein the level of influence is classified into two or more levels, and the influence level output unit outputs the level of influence, in association with each item, such that the classification of the level of influence can be visually seen.

With this configuration, it is possible to understand important items with ease. In particular, it is possible to quantitatively understand important items.

### Advantageous Effects of Invention

With the information processing apparatus according to the present invention, it is possible to understand important items with ease. In particular, it is possible to quantitatively understand important items.

### BRIEF DESCRIPTION OF DRAWINGS

FIG. 1 is a conceptual diagram of an information system A in Embodiment 1.

FIG. 2 is a block diagram of the information system A in this embodiment.

FIG. 3 is a flowchart illustrating an operation example of an information processing apparatus 1 in this embodiment.

FIG. 4 is a flowchart illustrating an example of score calculating processing in this embodiment.

FIG. 5 is a flowchart illustrating an example of influence level calculating processing in this embodiment.

FIG. 6 shows an item information management table in this embodiment.

FIG. 7 shows organization response information in this embodiment.

FIG. 8 shows an individual score table in this embodiment.

FIG. 9 shows an output example in this embodiment.

FIG. 10 shows an output example in this embodiment.

FIG. 11 is a schematic view of a computer system in this embodiment.

FIG. 12 is a block diagram of the computer system in this embodiment.

### DESCRIPTION OF EMBODIMENT

Hereinafter, an embodiment of an information processing apparatus and the like will be described with reference to the drawings. It should be noted that constituent elements denoted by the same reference numerals in the embodiments perform similar operations, and thus a description thereof may not be repeated.

### Embodiment 1

In this embodiment, an information system including an information processing apparatus that acquires and outputs a level of influence of two or more items on an organization overall score calculated from responses to items will be described. The organization may be broadly interpreted, and examples thereof include a so-called company self-employed person, local public entity and the like. The organization is, for example, an organization that performs some sort of job. The organization overall score may also be said to be an engagement score. The information system may also be said to be an engagement system. The information processing apparatus may also be said to be an engagement apparatus.

Furthermore, in this embodiment, an information system including an information processing apparatus that calculates an item score and an overall score of an organization also using an expectation level of each item will be described. The information system may also be said to be an engagement system.

Furthermore, in this embodiment, an information system including an information processing apparatus that has a score adjusting function of adjusting an overall score using correlation information regarding correlation between a satisfaction level and an expectation level will be described.

Furthermore, in this embodiment, an information system including an information processing apparatus that considers an attribute value of an organization, and outputs a different level of influence for each attribute value will be described.

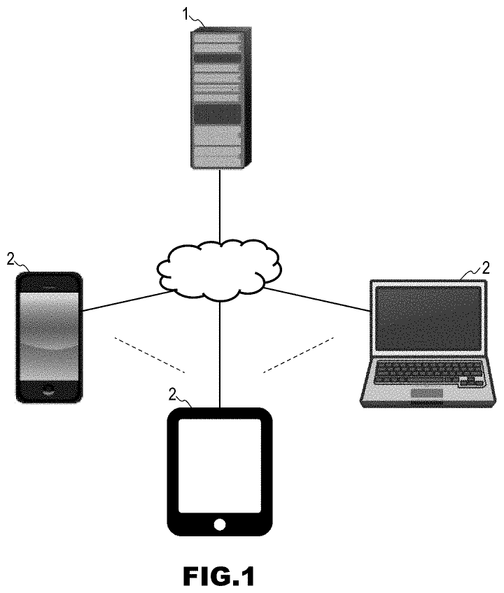

FIG. 1 is a conceptual diagram of an information system A in this embodiment. The information system A includes an information processing apparatus 1 and one or at least two terminal apparatuses 2. The information processing apparatus 1 in this example is a so-called server apparatus. The information processing apparatus 1 is, for example, a cloud server or an ASP server, and there is no limitation on the type or installation location thereof. Each terminal apparatus 2 is a mobile terminal such as a smartphone, a tablet device, or a mobile phone, a so-called personal computer, or the like, and there is no limitation on the type thereof.

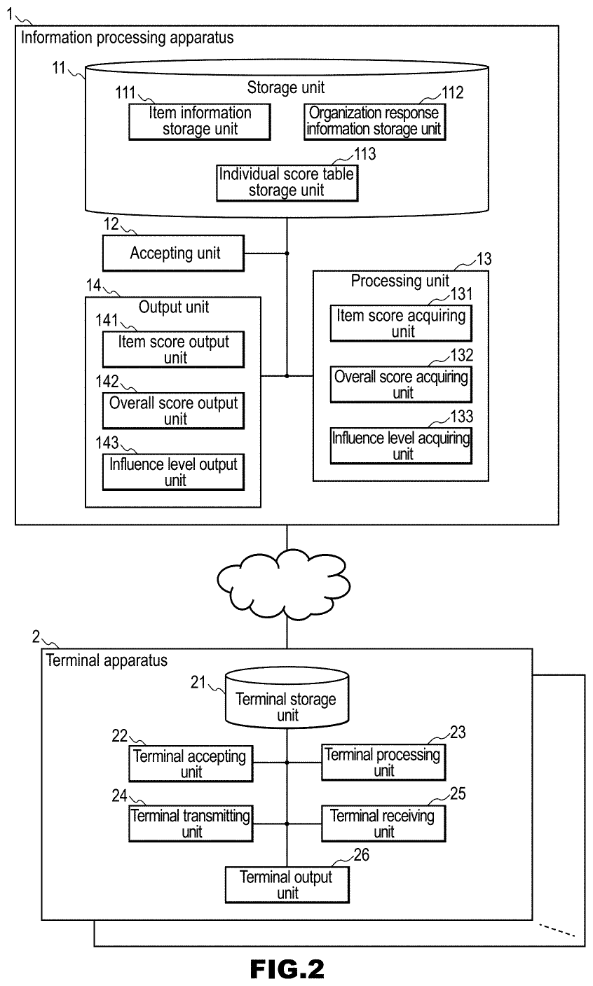

FIG. 2 is a block diagram of the information system A in this embodiment.

The information processing apparatus 1 includes a storage unit 11, an accepting unit 12, a processing unit 13, and an output unit 14. The storage unit 11 includes an item information storage unit 111, an organization response information storage unit 112, and an individual score table storage unit 113. The processing unit 13 includes an item score acquiring unit 131, an overall score acquiring unit 132, and an influence level acquiring unit 133. The output unit 14 includes an item score output unit 141, an overall score output unit 142, and an influence level output unit 143.

The terminal apparatus 2 includes a terminal storage unit 21, a terminal accepting unit 22, a terminal processing unit 23, a terminal transmitting unit 24, a terminal receiving unit 25, and a terminal output unit 26.

In the storage unit 11 constituting the information processing apparatus 1, various types of information are stored. The various types of information are, for example, later-described item information, later-described organization response information, and a later-described individual score table. The individual score table may also be said to be an engagement score table or the like.

In the item information storage unit 111, two or more pieces of item information are stored. The item information is information regarding an item of an organization. The item may be a question regarding an organization. The item may be associated with a question regarding an organization. The two or more items include, for example, an overall item regarding an overall matter of an organization, and an individual item, which is an individual item of the organization. The overall item is typically an item for a question with a high abstraction degree. The individual item is typically an item for a question with a lower abstraction degree (a more specific question). The two or more pieces of item information in the item information storage unit 111 have, for example, item information of four overall items and item information of 64 individual items. Each item corresponds to, for example, any one of the two or more objects. An object may also be said to be a factor. The object may also be said to be a matter regarding an organization. The item information has, for example, an item identifier for identifying an item, and question information. The item identifier is, for example, an ID, an item name, or the like. The item identifier may be question information itself. The question information is information indicating a question. The question is typically a question in a questionnaire. The matter may also be said to be an object or an item.

In the organization response information storage unit 112, organization response information of two or more organizations are stored. One piece of organization response information is a group of information on responses from two or more members of one organization. One piece of organization response information has two or more pieces of member response information respectively corresponding to two or more members. The member response information is information containing a response of a member to a question for an item. The member response information has two or more pieces of item response information. The number of pieces of item response information contained in the member response information is typically the same as the number of items. The item response information has an item identifier and response information. The response information is information regarding a response to a question. The response information has, for example, satisfaction level information. The satisfaction level information is information indicating a response regarding a satisfaction level of a member to an item. The satisfaction level information is, for example, information for specifying a satisfaction level to an item. The satisfaction level information is classified into two or more classes. The satisfaction level information may take, for example, any natural number of 1 to 5. Note that the satisfaction level information may be, for example, an evaluation value, such as A, B, and C, having the rank or order, or may be any natural number of 1 to 100. The response information has, for example, satisfaction level information and expectation level information. The expectation level information is information indicating a response regarding an expectation level of a member to an item. The expectation level information is, for example, information for specifying an expectation level to an item. The expectation level information is classified into two or more classes. The expectation level information may take, for example, any natural number of 1 to 5. Note that the expectation level information is, for example, an evaluation value, such as A, B, and C, having the rank or order, or may be any natural number of 1 to 100, for example. The member is, for example, an employee of a company, a staff member of a school, a staff member of a government office, or the like, but may also include an executive of a company and the like.

The overall item is, for example, a company satisfaction level indicating a level of being satisfied with a company, a job satisfaction level indicating a level of being satisfied with a job, a supervisor satisfaction level indicating a level of being satisfied with a supervisor, a workplace satisfaction level indicating a level of being satisfied with a workplace, or the like. The individual item is, for example, a business superiority of a company, transmission and transfer of a strategic objective, a sense of overall solidarity, validity of evaluation and salary or the like.

Furthermore, the organization response information is typically associated with an organization identifier. The organization identifier is an organization name, an ID for identifying an organization, or the like. It is preferable that the organization response information is associated with one or more attribute values of an organization. The attribute value is, for example, an industry type identifier indicating an industry type of an organization (e.g., bank, apparel, manufacturer, etc.), a size identifier for classifying a size of an organization (e.g., large enterprise, small-to-medium sized enterprise, self-employed, etc.), a region identifier indicating the region of a home office, or the like.

In the individual score table storage unit 113, an individual score table is stored. The individual score table in this example is, information in which, if satisfaction level information and expectation level information are given, an item score is decided on. The individual score table in this example is, for example, a table having an axis of satisfaction level information and an axis of expectation level information, wherein table cells respectively show individual scores, so that, if satisfaction level information and expectation level information are decided on, an item score is decided on. This individual score table is preferably a table in which the larger the satisfaction level indicated by the satisfaction level information is, the larger the acquired item score is, and the smaller the expectation level indicated by the expectation level information is, the larger the acquired item score is.

It is also possible to decide on an item score, using an operation expression having, as parameters, satisfaction level information and expectation level information. This operation expression is preferably an increasing function having, as a parameter, satisfaction level information, and a decreasing function having, as a parameter, expectation level information.

Furthermore, it is also possible to learn multiple sets of satisfaction level information, expectation level information, and an item score through machine learning, and to decide on an item score using the acquired learning information. In this case, satisfaction level information and expectation level information are applied to learning information, and an item score is acquired through machine learning. As the machine learning in this example, for example, SVR, deep learning, decision trees, and the like are available. Note that there is no limitation on the algorithm of the machine learning.

The accepting unit 12 accepts various types of information or instructions. The various types of information or instructions are, for example, a score, etc. output instruction, organization response information, questionnaire response information (member response information), or the like. The score, etc. output instruction is an instruction to output a score or the like. The receiving is typically receiving from the terminal apparatus 2, but may be considered as a concept that also encompasses accepting information input from an input device such as a keyboard, a mouse, or a touch panel, accepting information read from a storage medium such as an optical disk, a magnetic disk, or a semiconductor memory, and the like.

The processing unit 13 performs various types of processing. The various types of processing are, for example, processes that are performed by the item score acquiring unit 131, the overall score acquiring unit 132, and the influence level acquiring unit 133. The various types of processing are, for example, a process that accumulates received organization response information, questionnaire response information, or the like in the storage unit 11.

The item score acquiring unit 131 performs statistical processing on the response information of the members to the two or more items contained in the two or more pieces of organization response information, thereby acquiring an item score for each organization and for each item.

For example, the item score acquiring unit 131 performs, for each organization, statistical processing on the satisfaction level information contained in the response information of the two or more items contained in the organization response information of the organization, thereby acquiring an item score for each organization and for each item. For example, the item score acquiring unit 131 may calculate an average value of the satisfaction level information for each organization and for each item, and accumulate the average value as an item score in an unshown buffer or the storage unit 11 so as to be paired with the item identifier. For example, the item score acquiring unit 131 may, for each organization and for each item, perform different weighting according to a member's attribute value, calculate a weighted average value of the satisfaction level, and accumulate the weighted average value as an item score in an unshown buffer or the storage unit 11 so as to be paired with the item identifier. The member's attribute value is, for example, the position, the length of service, the sex, or the like. For example, the item score acquiring unit 131 may calculate a weighted average value while making the weight of the satisfaction level information of a long-service employee greater than that of a short-service employee.

The item score acquiring unit 131 acquires item scores of at least some of the items, using the satisfaction level information and the expectation level information. The item for which an item score is acquired using the satisfaction level information and the expectation level information is, for example, an individual item.

It is preferable that the item score acquiring unit 131 acquires an item score, for example, such that the higher the satisfaction level information is, the higher the score is, and such that the lower the expectation level information is, the higher the score is.

The item score acquiring unit 131 calculates, for example, for each of the two or more organizations and for each of the two or more items, an average value of the satisfaction level information contained in the response information and an average value of the expectation level information contained in the response information, and acquires an item score for each item using the two average values.

The item score acquiring unit 131 may, for example, apply the satisfaction level information and the expectation level information to the individual score table, thereby acquiring an item score for each item. The item score acquiring unit 131 may, for example, apply a statistical processing result of the satisfaction level information and a statistical processing result of the expectation level information to the individual score table, thereby acquiring an item score for each item. The item score acquiring unit 131 may, for example, apply an average value of the satisfaction level information and an average value of the expectation level information to the individual score table, thereby acquiring an item score for each item. The item score acquiring unit 131 may, for example, apply a weighted average value of the satisfaction level information and a weighted average value of the expectation level information to the individual score table, thereby acquiring an item score for each item. The weighted average value is a weighted average value based on a member's attribute value.

The item score acquiring unit 131 may, for example, calculate an item score for each item, using a function that is an increasing function having, as a parameter, an average value of the satisfaction level information, and is a decreasing function having, as a parameter, an average value of the expectation level information.

The overall score acquiring unit 132 acquires an overall score for two or more pieces of organization response information, using two or more item scores. The overall score is an overall score of an organization. Typically, the higher each of the two or more item scores is, the higher the overall score acquired by the overall score acquiring unit 132 is.

The overall score acquiring unit 132 preferably acquires an overall score using a score adjusting function as follows. The score adjusting function is a function of adjusting a score using correlation information regarding the degree of correlation between the satisfaction level information and the expectation level information. In this example, it is preferable to set the score adjusting function such that the higher the correlation between the satisfaction level information and the expectation level information is, the higher the overall score is.

The overall score acquiring unit 132 acquires, for example, for each organization, a tentative overall score, which is a tentative overall score of each organization, using two or more item scores, acquires correlation information regarding the degree of correlation between the satisfaction level information and the expectation level information for each of the two or more items, and acquires an overall score from the tentative overall score using the correlation information such that the higher the degree of correlation is, the higher the score is. The correlation information may be a correlation value between a group of satisfaction level information and a group of expectation level information for two or more items, a value calculated using an operation expression that is an increasing function having, as a parameter, the number of items in which a difference between satisfaction level information for each of the two or more items and expectation level information for each of the two or more items is less than or equal to a threshold, or a value calculated using an operation expression that is a decreasing function having, as a parameter, the number of items in which a difference between satisfaction level information for each of the two or more items and expectation level information for each of the two or more items is less than or equal to a threshold, and the satisfaction level information is smaller. That is to say, there is no limitation on the algorithm for acquiring correlation information.

The overall score acquiring unit 132 preferably acquires an overall score, using both item scores of overall items and item scores of individual items while making the weights of item scores of overall items greater than those of item scores of the individual items.

The overall score acquiring unit 132 may, for example, calculate an overall score, using the equation “overall score=α×statistical score of item scores of overall items+β×statistical score of item scores of individual items”. In this example, it is preferable that (α>β). That is to say the overall score acquiring unit 132 preferably acquires an overall score while making the weights of item scores of overall items greater than those of item scores of the individual items. For example, “α=0.7, β=0.3”. The statistical score of item scores of overall items is, for example, an average value, a weighted average value, or the like of item scores of overall items. The statistical score of item scores of individual items is, for example, an average value, a weighted average value, or the like of item scores of individual items.

Furthermore, the overall score acquiring unit 132 may for example, calculate a tentative overall score, using the equation “tentative overall score=α×statistical score of item scores of overall items+β×statistical score of item scores of individual items”, perform score adjustment using the above-described score adjusting function, and calculate an overall score. The overall score acquiring unit 132 may, for example, calculate a deviation of an overall score of each organization, using overall scores of multiple organizations, and take the deviation as a final overall score.

The influence level acquiring unit 133 acquires, for each item, a level of influence of item scores on overall scores. The level of influence of item scores on overall scores may also be said to be a level of influence of an item on an overall score.

The influence level acquiring unit 133 acquires, for each item, an level of influence of item scores of the item on overall scores, using the item scores of the two or more items of the two or more organizations and the overall scores of the two or more organizations. The level of influence is, for example, information indicating influence of item scores on overall scores, and is a degree of correlation of a group of item scores of multiple organizations with respect to a group of overall scores of the multiple organizations. The processing for acquiring a degree of correlation, correlation values, and correlation information is a known technique, and thus a detailed description thereof has been omitted.

The influence level acquiring unit 133 calculates, for each item, a level of influence, which is information regarding correlation between item scores of the item and overall scores, using the overall scores of the two or more organizations and the item scores of the item of the two or more organizations.

It is preferable that the influence level acquiring unit 133 acquires, for each item, an level of influence of item scores of the item on overall scores, for each attribute value of an organization. That is to say, if the attribute value of an organization is an industry type identifier, the influence level acquiring unit 133 preferably acquires, for each item, level of influence of the item, for each industry type according to the industry type identifier.

The output unit 14 outputs various types of information. The various types of information are, for example, a group of information composed of pairs of an item identifier and an item score. The various types of information are, for example, overall scores. The various types of information are, for example, a group of information composed of pairs of an item identifier and a level of influence. The output is typically transmission to an external apparatus such as the terminal apparatus 2. Note that the output may be considered as a concept that also encompasses display on a display screen, projection using a projector, printing by a printer, output of a sound, accumulation in a storage medium, delivery of a processing result to another processing apparatus or another program, and the like.

The item score output unit 141 outputs one or at least two item scores. The item score output unit 141 typically outputs an item score of an item identified with an item identifier, in association with the item identifier. The item score output unit 141 outputs, for example, an item score paired with an organization identifier contained in a score, etc. output instruction, in association with the item identifier. It is preferable that the item score output unit 141 outputs one or more item scores, in association with the organization identifier. It is preferable that the item score output unit 141 outputs item scores such that item scores of overall items and item scores of individual items can be visually distinguished from each other.

The overall score output unit 142 outputs an overall score. It is preferable that the overall score output unit 142 outputs an overall score in association with the organization identifier.

The influence level output unit 143 outputs the level of influence acquired by the influence level acquiring unit 133, in association with each item. It is preferable that the influence level output unit 143 outputs the level of influence acquired by the influence level acquiring unit 133, in association with the item identifier of each item.

Furthermore, it is preferable that the influence level output unit 143 outputs the level of influence, in association with each item, such that the classification of the level of influence can be visually seen.

In the terminal storage unit 21 constituting the terminal apparatus 2, various types of information are stored. The various types of information are, for example, an organization identifier for identifying an organization of a user. The various types of information are, for example, information received by the terminal receiving unit 25. The organization identifier may be regarded as information for identifying a user.

The terminal accepting unit 22 accepts various types of instructions, information, or the like. The accepting is a concept that encompasses accepting information input from an input device such as a keyboard, a mouse, or a touch panel, receiving information transmitted via a wired or wireless communication line, accepting information read from a storage medium such as an optical disk, a magnetic disk, or a semiconductor memory, and the like. The various types of instructions, information, or the like is, for example, a score, etc. output instruction, organization response information, questionnaire response information, or the like.

The various types of instructions, information, or the like may be input by any part such as a touch panel, a keyboard, a mouse, a menu screen, or the like. The terminal accepting unit 22 may be realized as a device driver for an input part such as a touch panel or a keyboard, software for controlling a menu screen, or the like.

The terminal processing unit 23 performs various types of processing, which are, for example, a process that configures data that is to be displayed, from the information received by the terminal receiving unit 25. The various types of processing are, for example, a process that configures instructions or the like that is to be transmitted, from the instructions or the like accepted by the terminal accepting unit 22.

The terminal transmitting unit 24 transmits the various types of instructions, information, or the like to the information processing apparatus 1. The various types of instructions, information, or the like are, for example, the instructions configured by the terminal processing unit 23, or the instructions, information, or the like accepted by the terminal accepting unit 22.

The terminal receiving unit 25 receives various types of information from the information processing apparatus 1. The various types of information are, for example, item scores, overall scores, or levels of influence.

The storage unit 11 is preferably a non-volatile storage medium, but can also be realized by a volatile storage medium.

There is no limitation on the procedure in which information is stored in the storage unit 11, the item information storage unit 111, the organization response information storage unit 112, the individual score table storage unit 113, and the terminal storage unit 21. For example, information may be stored in the storage unit 11 and the like via a storage medium, information transmitted via a communication line or the like may be stored in the storage unit 11 and the like, or information input via an input device may be stored in the storage unit 11 and the like.

The accepting unit 12 and the terminal receiving unit 25 are typically realized by a wireless or wired communication part, but can also be realized by a broadcast receiving part.

The processing unit 13, the item score acquiring unit 131, the overall score acquiring unit 132, the influence level acquiring unit 133, and the terminal processing unit 23 are realized typically by MPUs, memories, or the like. Typically, the processing procedure of the processing unit 13 and the like is realized by software, and the software is stored in a storage medium such as a ROM. Note that the processing unit 13 and the like may be realized also by hardware (dedicated circuits).

The output unit 14, the item score output unit 141, the overall score output unit 142, the influence level output unit 143, and the terminal transmitting unit 24 are typically realized by a wireless or wired communication part, but can also be realized by a broadcasting part.

The terminal output unit 26 may be considered to include or to not include an output device such as a display screen or a speaker. The terminal output unit 26 may be realized by driver software for an output device, a combination of driver software for an output device and the output device, or the like.

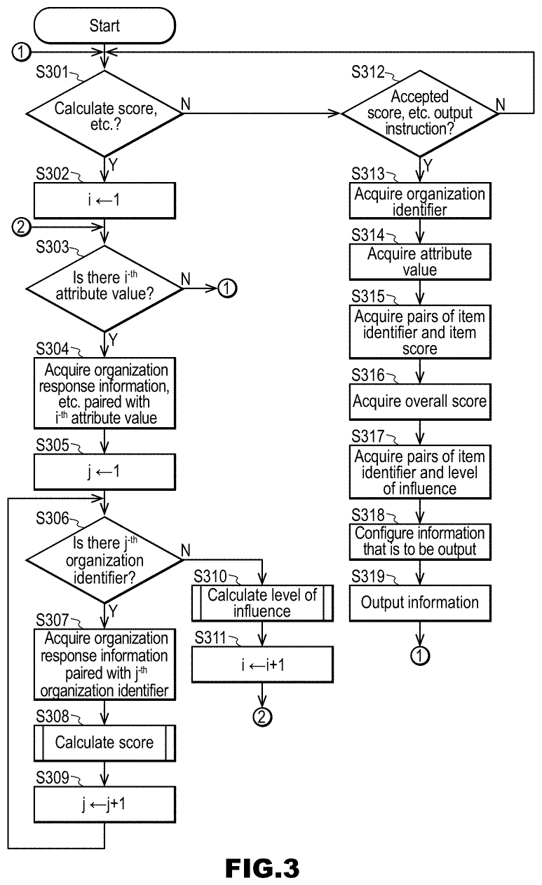

Next, an operation of the information system A will be described. First, an operation example of the information processing apparatus 1 will be described with reference to the flowchart in FIG. 3. It is assumed that, in the organization response information storage unit 112, organization response information of multiple organizations is stored. Also, it is assumed that, in the individual score table storage unit 113, an individual score table is stored.

(Step S301) The processing unit 13 judges whether or not it is time to calculate a score or the like. If it is time to calculate a score or the like, the procedure advances to step S302, and, if otherwise, the procedure advances to step S312. The time to calculate a score or the like is, for example, a case in which an instruction is input from a user, an administrator, or the like, a case in which a predetermined time is reached, a case in which two or more pieces of organization response information are received and accumulated in the organization response information storage unit 112, or the like.

(Step S302) The processing unit 13 substitutes 1 for a counter i.

(Step S303) The processing unit 13 judges whether or not there is an i-^{th} attribute value. If there is an i-^{th} attribute value, the procedure advances to step S304, and, if otherwise, the procedure returns to step S301. The i-^{th} attribute value is an i-^{th} attribute value of an organization, and is an attribute value for which a level of influence is to be calculated.

(Step S304) The processing unit 13 acquires two or more pieces of organization response information and the like paired with the i-^{th} attribute value, from the organization response information storage unit 112. The organization response information and the like are, for example, an organization identifier and organization response information. The organization response information and the like are, for example, an organization identifier, an i-^{th} attribute value, and organization response information.

(Step S305) The processing unit 13 substitutes 1 for a counter j.

(Step S306) The processing unit 13 judges whether or not there is a j-^{th} organization identifier, in the two or more pieces of organization response information and the like acquired in step S304. If there is a j-^{th} organization identifier, the procedure advances to step S307, and, if otherwise, the procedure advances to step S310.

(Step S307) The processing unit 13 acquires organization response information paired with the j-^{th} organization identifier.

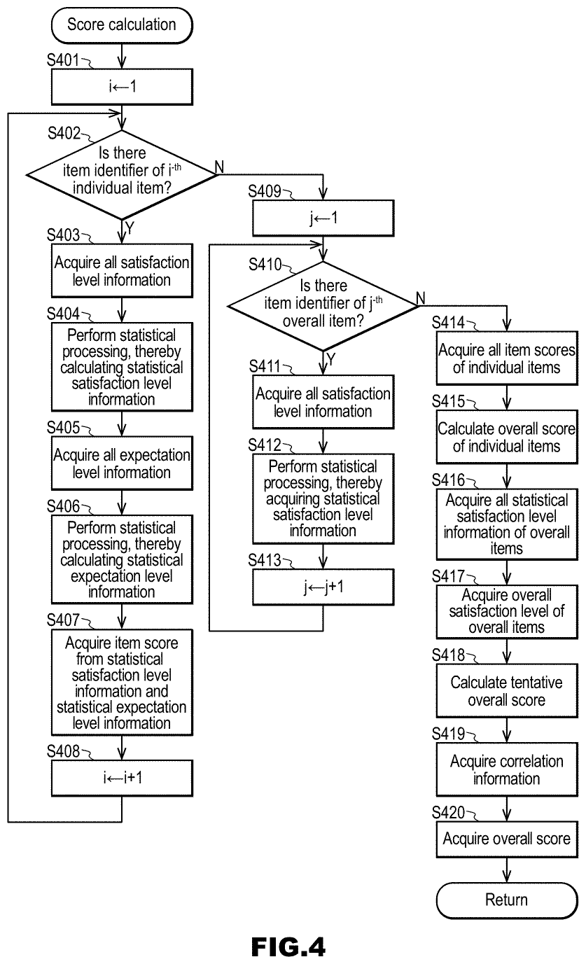

(Step S308) The processing unit 13 calculates various scores corresponding to the j-^{th} organization identifier, using the organization response information acquired in step S307. It is assumed that calculating scores is the same as acquiring scores. Later, the score calculating processing will be described with reference to the flowchart in FIG. 4.

(Step S309) The processing unit 13 increments the counter j by 1. The procedure returns to step S306.

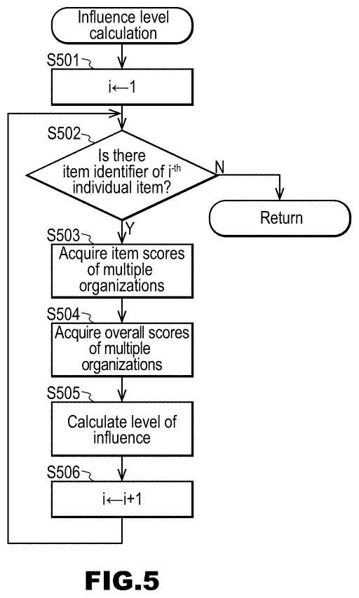

(Step S310) The influence level acquiring unit 133 calculates the level of influence of each item. Later, the influence level calculating processing will be described with reference to the flowchart in FIG. 5.

(Step S311) The processing unit 13 increments the counter i by 1. The procedure returns to step S303.

(Step S312) The accepting unit 12 judges whether or not it has accepted a score, etc. output instruction. If it has accepted a score, etc. output instruction, the procedure advances to step S313, and, if otherwise, the procedure returns to step S301.

(Step S313) The processing unit 13 acquires an organization identifier contained in the score, etc. output instruction accepted in step S312.

(Step S314) The processing unit 13 acquires an attribute value of an organization paired with the organization identifier acquired in step S313.

(Step S315) The processing unit 13 acquires two or more item scores paired with the organization identifier acquired in step S313 and item identifiers paired with the item scores, from the storage unit 11 or an unshown buffer. That is to say, the processing unit 13 acquires pairs of an item identifier and an item score, the pairs being as many as the items.

(Step S316) The processing unit 13 acquires an overall score paired with the organization identifier acquired in step S313, from the storage unit 11 or an unshown buffer.

(Step S317) The processing unit 13 acquires two or more levels of influence paired with the attribute value acquired in step S314 and item identifiers paired with the levels of influence, from the storage unit 11 or an unshown buffer. That is to say, the processing unit 13 acquires pairs of an item identifier and a level of influence, the pairs being as many as the items.

(Step S318) The processing unit 13 configures information that is to be output, from the information acquired in steps S315, S316, and S317.

(Step S319) The output unit 14 outputs the information configured in step S318. The procedure returns to step S301. The output is typically transmission to the terminal apparatus 2 from which the score, etc. output instruction was transmitted. It is assumed that the information that is to be output contains at least a pair of an item identifier and a level of influence. It is preferable that the information that is to be output contains a pair of an item identifier and an item score, and an overall score.

In the flowchart in FIG. 3, there is no limitation on the route through which organization response information is accumulated in the organization response information storage unit 112.

Furthermore, in the flowchart in FIG. 3, a level of influence is acquired for each attribute value of an organization. However, it will be appreciated that the level of influence of each item may be acquired using the organization response information of all organizations, regardless of attribute values of the organizations.

In the flowchart shown in FIG. 3, processing ends at power off or at an interruption of ending processing.

Next, an example of the score calculating processing in step S308 will be described with reference to the flowchart in FIG. 4.

(Step S401) The item score acquiring unit 131 substitutes 1 for a counter i.

(Step S402) The item score acquiring unit 131 judges whether or not there is an item identifier of an i-^{th} individual item, in the organization response information acquired in step S307. If there is an item identifier of an i-^{th} individual item, the procedure advances to step S403, and, if otherwise, the procedure advances to step S409.

(Step S403) The item score acquiring unit 131 acquires satisfaction level information of all members paired with the item identifier of the i-^{th} individual item, in the organization response information acquired in step S307.

(Step S404) The item score acquiring unit 131 performs statistical processing on the satisfaction level information acquired in step S403, thereby calculating statistical satisfaction level information. In this case, for example, the item score acquiring unit 131 calculates statistical satisfaction level information, which is an average value of the satisfaction level information acquired in step S403. Then, the item score acquiring unit 131 accumulates the calculated statistical satisfaction level information in the storage unit 11 or an unshown buffer so as to be paired with the item identifier of the i-^{th} individual item.

(Step S405) The item score acquiring unit 131 acquires expectation level information of all members paired with the item identifier of the i-^{th} individual item, in the organization response information acquired in step S307.

(Step S406) The item score acquiring unit 131 performs statistical processing on the expectation level information acquired in step S405, thereby calculating statistical expectation level information. In this case, for example, the item score acquiring unit 131 calculates statistical expectation level information, which is an average value of the expectation level information acquired in step S403. Then, the item score acquiring unit 131 accumulates the calculated statistical expectation level information in the storage unit 11 or an unshown buffer so as to be paired with the item identifier of the i-^{th} individual item.

(Step S407) The item score acquiring unit 131 acquires an item score of the i-^{th} individual item of the organization of interest, using the statistical satisfaction level information and the statistical expectation level information. The item score acquiring unit 131 applies the statistical satisfaction level information and the statistical expectation level information to the individual score table in the individual score table storage unit 113, thereby acquiring an item score of the i-^{th} individual item. Then, the item score acquiring unit 131 accumulates the acquired item score in the storage unit 11 or an unshown buffer so as to be paired with the item identifier of the i-^{th} individual item.

(Step S408) The item score acquiring unit 131 increments the counter i by 1. The procedure returns to step S402.

(Step S409) The item score acquiring unit 131 substitutes 1 for a counter j.

(Step S410) The item score acquiring unit 131 judges whether or not there is an item identifier of a j-^{th} overall item, in the organization response information acquired in step S307. If there is an item identifier of a j-^{th} overall item, the procedure advances to step S411, and, if otherwise, the procedure advances to step S414.

(Step S411) The item score acquiring unit 131 acquires satisfaction level information of all members paired with the item identifier of the j-^{th} overall item, in the organization response information acquired in step S307.

(Step S412) The item score acquiring unit 131 performs statistical processing on the satisfaction level information acquired in step S411, thereby calculating statistical satisfaction level information. In this case, for example, the item score acquiring unit 131 calculates statistical satisfaction level information, which is an average value of the satisfaction level information acquired in step S411. Then, the item score acquiring unit 131 accumulates the calculated statistical satisfaction level information in the storage unit 11 or an unshown buffer so as to be paired with the item identifier of the j-^{th} overall item.

(Step S413) The item score acquiring unit 131 increments the counter j by 1. The procedure returns to step S410.

(Step S414) The overall score acquiring unit 132 acquires all item scores of the individual items, from the storage unit 11 or an unshown buffer. The item scores of the individual items are scores acquired in step S407.

(Step S415) The overall score acquiring unit 132 acquires an overall score of the individual items, from all item scores acquired in step S414. For example, the overall score acquiring unit 132 calculates an average value of all item scores acquired in step S414, and acquires the average value as an overall score of the individual items.

(Step S416) The overall score acquiring unit 132 acquires statistical satisfaction level information of all items of the overall items, from the storage unit 11 or an unshown buffer.

(Step S417) The overall score acquiring unit 132 performs statistical processing on the statistical satisfaction level information of all items acquired in step S416, thereby calculating statistical satisfaction level information of the overall items. For example, the overall score acquiring unit 132 calculates an average value of the statistical satisfaction level information of all items acquired in step S416, and acquires the average value as statistical satisfaction level information of the overall items.

(Step S418) The overall score acquiring unit 132 calculates a tentative overall score, from the overall score of the individual items acquired in step S415 and the statistical satisfaction level information of the overall items acquired in step S417. For example, the overall score acquiring unit 132 calculates a tentative overall score, using the operation expression “tentative overall score=α×statistical satisfaction level information of overall items+β×overall score of individual items”.

(Step S419) The overall score acquiring unit 132 acquires correlation information regarding correlation between a group of the satisfaction level information and a group of the expectation level information, from the group of the satisfaction level information of all individual items and the group of the expectation level information of all individual items.

(Step S420) The overall score acquiring unit 132 adjusts the tentative overall score acquired in step S418, using the correlation information acquired in step S419, thereby acquiring an overall score. The procedure returns to the upper-level processing. The overall score acquiring unit 132 acquires an overall score such that the higher the degree of correlation indicated by the correlation information is, the higher the overall score is.

Next, an example of the influence level calculating processing in step S310 will be described with reference to the flowchart in FIG. 5.

(Step S501) The influence level acquiring unit 133 substitutes 1 for a counter i.

(Step S502) The influence level acquiring unit 133 judges whether or not there is an item identifier of an i-^{th} individual item, in the two or more pieces of organization response information and the like acquired in step S304. If there is an item identifier of an i-^{th} individual item, the procedure advances to step S503, and, if otherwise, the procedure returns to the upper-level processing.

(Step S503) The influence level acquiring unit 133 acquires item scores of multiple organizations paired with the item identifier of the i-^{th} individual item, from the two or more pieces of organization response information and the like acquired in step S304.

(Step S504) The influence level acquiring unit 133 acquires overall scores of the multiple organizations, from the two or more pieces of organization response information and the like acquired in step S304.

(Step S505) The influence level acquiring unit 133 acquires a level of influence indicating a degree of correlation between the multiple item scores acquired in step S503 and the multiple overall scores acquired in step S504. Then, the influence level acquiring unit 133 accumulates the acquired level of influence in the storage unit 11 or an unshown buffer so as to be paired with the item identifier of the i-^{th} individual item.

(Step S506) The influence level acquiring unit 133 increments the counter i by 1. The procedure returns to step S502.

Next, an operation of the terminal apparatus 2 will be described. The terminal accepting unit 22 of the terminal apparatus 2 accepts various types of instructions, information, or the like. Next, the terminal processing unit 23 configures instructions or the like that is to be transmitted, from the instructions or the like accepted by the terminal accepting unit 22. The terminal transmitting unit 24 transmits the instructions or the like configured by the terminal processing unit 23, to the information processing apparatus 1. In response to transmission of the instructions or the like, the terminal receiving unit 25 receives information from the information processing apparatus 1. Next, the terminal processing unit 23 configures data that is to be output, from the information received by the terminal receiving unit 25. Next, the terminal output unit 26 outputs the information configured by the terminal processing unit 23.

Hereinafter, a specific operation of the information system A in this embodiment will be described. FIG. 1 is a conceptual diagram of the information system A.

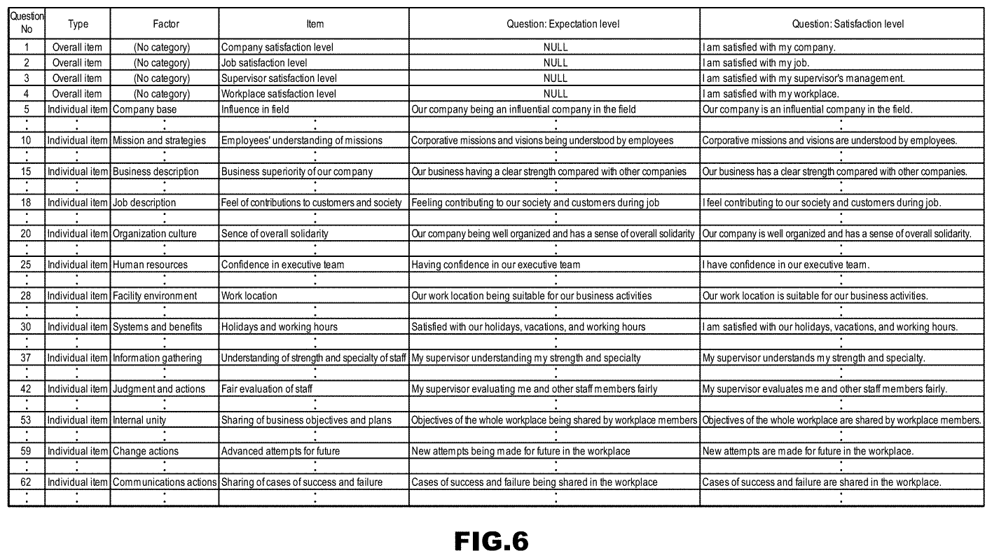

It is assumed that the item information management table shown in FIG. 6 is stored in the item information storage unit 111. The item information management table is a table for managing a large number of pieces of item information each indicating an item of a questionnaire to a member (an employee in this example) of an organization (a company in this example). The item information in this example has “question No”, “type”, “factor”, “item”, “question: expectation level”, and “question: satisfaction level”. “Question No” is an ID for identifying a question, and is an example of an item identifier. “Type” is information indicating the type of item, and, in this example, may be either an overall item or an individual item. “Factor” is a middle concept of an item, and may also be said to be an object. “Item” is information indicating the content of an item. “Item” may be regarded as an item identifier. “Question: expectation level” is a question for acquiring expectation level information. “Question: satisfaction level” is a question for acquiring satisfaction level information.

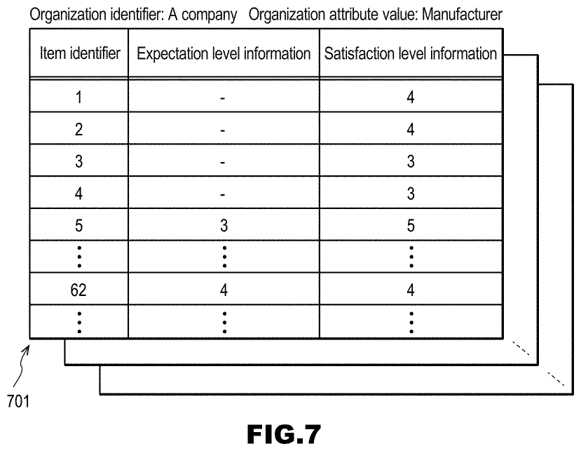

Furthermore, for example, the organization response information shown in FIG. 7 is stored in the organization response information storage unit 112. Two or more pieces of organization response information are stored in the organization response information storage unit 112. FIG. 7 shows organization response information of an organization identified with the organization identifier “A company”. 701 denotes member response information of one employee of the organization identified with the organization identifier “A company”. The organization response information of an organization identified with the organization identifier “A company” contains member response information of two or more employees. The member response information has a large number of (63 or more) records each having “item identifier”, “expectation level information”, and “satisfaction level information”. The record of an item with an item identifier of 1 to 4 is a record of an overall item, and has no expectation level information. Then, the expectation level information and the satisfaction level information constituting the member response information of 701 are information acquired from responses of an employee to “question: expectation level” and “question: satisfaction level” of the item information management table shown in FIG. 6. This responses in this example are responses indicated by a natural number of 1 to 5. In this example, if the expectation level information to “question: expectation level” is 1, the expectation level is lowest, and, if the expectation level information is 5, the expectation level is highest. If the satisfaction level information to “Question: satisfaction level” is 1, the satisfaction level is lowest, and, if the satisfaction level information is 5, the satisfaction level is highest. Furthermore, it is assumed that the attribute value of the industry type of the organization identified with the organization identifier “A company” is “manufacturer”.

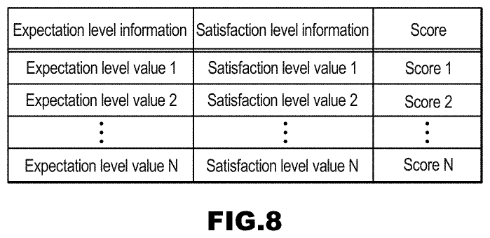

Furthermore, the individual score table shown in FIG. 8 is stored in the individual score table storage unit 113. In the individual score table, two or more records each having “expectation level information”, “satisfaction level information”, and “score” are managed. “Expectation level information” is, for example, an average value of the expectation level information. “Expectation level information” may be, for example, information indicating the range of an average value of the expectation level information. “Expectation level value 1”, “expectation level value 2” . . . , and “expectation level value N”, which are attribute values of “expectation level information”, are information indicating specific values or ranges. “Satisfaction level information” is, for example, an average value of the satisfaction level information. “Satisfaction level information” may be, for example, information indicating the range of an average value of the satisfaction level information. “Satisfaction level value 1”, “satisfaction level value 2” . . . , and “satisfaction level value N”, which are attribute values of “satisfaction level information”, are information indicating specific values or ranges. “Score” in this example is information indicating an item score. “Score 1”, “score 2” . . . , and “score N”, which are attribute values of “score”, are specific values.

In this situation, it is assumed that an administrator of the information processing apparatus 1 inputs an instruction to calculate a score or the like. Then, the accepting unit 12 accepts the instruction to calculate a score or the like. Next, the processing unit 13 judges that it is time to calculate a score or the like.

Next, the processing unit 13 acquires two or more pieces of organization response information and the like paired with the attribute value “manufacturer”, from the organization response information management table (FIG. 7).

Next, the processing unit 13 calculates an item score of each item and an overall score for organization identifiers paired with the attribute value “manufacturer”, such as “A company”, using the organization response information paired with the organization identifiers. Hereinafter, calculation of an item score and an overall score will be described using “A company” as an example.

That is to say the item score acquiring unit 131 acquires member response information paired with the organization identifier “A company”. Then, the item score acquiring unit 131 acquires, for each individual item, satisfaction level information of all members, from the acquired member response information. Next, the item score acquiring unit 131 acquires an average value of the acquired satisfaction level information, as the statistical satisfaction level information of each individual item. The item score acquiring unit 131 acquires an average value of the acquired expectation level information, as the statistical expectation level information of each individual item. Next, the item score acquiring unit 131 applies the statistical satisfaction level information and the statistical expectation level information to the individual score table in FIG. 8, thereby acquiring an item score of each individual item. Then, the item score acquiring unit 131 accumulates the acquired item score in a buffer so as to be paired with the item identifier of each individual item.

Next, the item score acquiring unit 131 acquires satisfaction level information of all members corresponding to the item identifier of each overall item. Then, the item score acquiring unit 131 calculates, for each overall item, an average value of the acquired satisfaction level information, and acquires the average value as statistical satisfaction level information. Next, the item score acquiring unit 131 accumulates the statistical satisfaction level information of each overall item in a buffer so as to be paired with the item identifier of each overall item.

Next, the overall score acquiring unit 132 acquires an overall score of all item scores of all individual items. In this example, the overall score acquiring unit 132 acquires an average value of all item scores of all individual items.

Next, the overall score acquiring unit 132 performs statistical processing on the statistical satisfaction level information of all items, thereby calculating statistical satisfaction level information of the overall items. In this example, the overall score acquiring unit 132 acquires an average value of the statistical satisfaction level information of all items, as the statistical satisfaction level information of the overall items.

Next, the overall score acquiring unit 132 calculates a tentative overall score, using the operation expression “tentative overall score=0.7×statistical satisfaction level information of overall items+0.3×overall score of individual items”.

Next, the overall score acquiring unit 132 acquires correlation information regarding correlation between a group of the satisfaction level information and a group of the expectation level information, from the group of the satisfaction level information of all individual items and the group of the expectation level information of all individual items.

Next, the overall score acquiring unit 132 adjusts the acquired tentative overall score, using the acquired correlation information. The overall score acquiring unit 132 acquires a deviation, also using the values obtained by adjusting tentative overall scores of the other companies. This deviation is an overall score. In this case, it is assumed that the overall score acquiring unit 132 calculates an overall score “68.0” of an organization identified with the organization identifier “A company”. Then, the overall score acquiring unit 132 accumulates the overall score “68.0” in a buffer in association with the organization identifier “A company”. The values obtained by adjusting tentative overall scores of the other companies are calculated as in the case of the calculation of the value of “A company”.

Then, the above-described processing is performed also on other organization response information paired with the attribute value “manufacturer”. Then, it is assumed that item scores of individual items and overall scores are calculated from all organization response information (organizations) paired with the attribute value “manufacturer”, and are at least temporarily stored in the buffer.

Next, the influence level acquiring unit 133 acquires, for each individual item, item scores paired with the organization identifiers paired with the attribute value “manufacturer”, from the buffer. That is to say the influence level acquiring unit 133 acquires item scores from the buffer, the item scores being as many as the organization identifiers. Next, the influence level acquiring unit 133 acquires overall scores paired with the organization identifiers paired with the attribute value “manufacturer”, from the buffer.

Next, the influence level acquiring unit 133 calculates a degree of correlation between a group of the acquired multiple item scores and a group of the acquired multiple overall scores, for each individual item. The degree of correlation also may be a correlation coefficient. Then, the influence level acquiring unit 133 accumulates, for each individual item, the level of influence, which is the degree of correlation, in the buffer so as to be paired with the item identifier. It is assumed that this information has a structure “item identifier, level of influence” that is, in this case, for example, “influence in field, 0.84”, “stability of customer base, 0.78”, “popularity and name recognition, 0.65”, “soundness of financial condition, 0.86”, “transmission and transfer of missions, 0.50”, “understanding of missions, 0.82”, “transmission and transfer of strategic objective, 0.78”, “satisfaction with strategic objective, 0.50”, or the like.

Furthermore, the above-described processing is performed also on organization response information corresponding to the other attribute values (e.g., “trading company”, “bank”, etc.).

Then, it is assumed that item scores and an overall score are accumulated for each company, and, furthermore, in this case, the level of influence of each item is accumulated for each attribute value of an organization.

It is assumed that, in this case, a user of “A company” inputs a score, etc. output instruction to the terminal apparatus 2. Next, the terminal apparatus 2 accepts the score, etc. output instruction, and configures a score, etc. output instruction having the organization identifier “A company”. Then, the terminal apparatus 2 transmits the score, etc. output instruction to the information processing apparatus 1.

Next, the accepting unit 12 of the information processing apparatus 1 receives the score, etc. output instruction from the terminal apparatus 2. Next, the processing unit 13 acquires an organization identifier “A company” contained in the score, etc. output instruction. Next, the processing unit 13 acquires an attribute value “manufacturer” of an organization paired with the organization identifier “A company”.

Next, the processing unit 13 acquires two or more item scores paired with the organization identifier “A company” and item identifiers paired with the item scores, from the storage unit 11 or an unshown buffer.

Next, the processing unit 13 acquires an overall score “68.0” paired with the organization identifier “A company”, from the storage unit 11 or an unshown buffer.

Next, the processing unit 13 acquires two or more levels of influence paired with the acquire attribute value “manufacturer”, and item identifiers paired with the levels of influence, from the storage unit 11 or an unshown buffer.

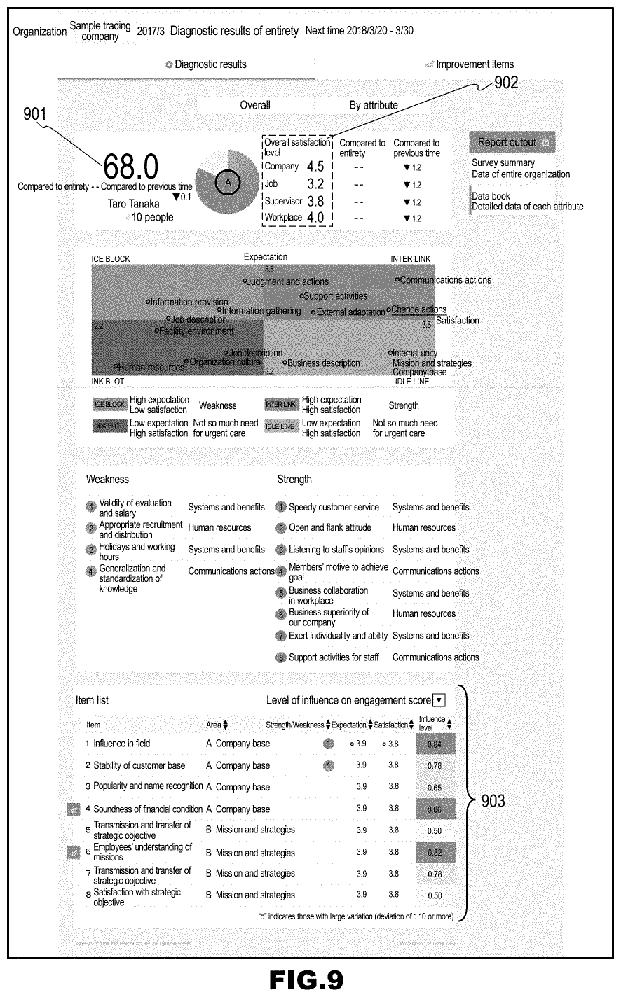

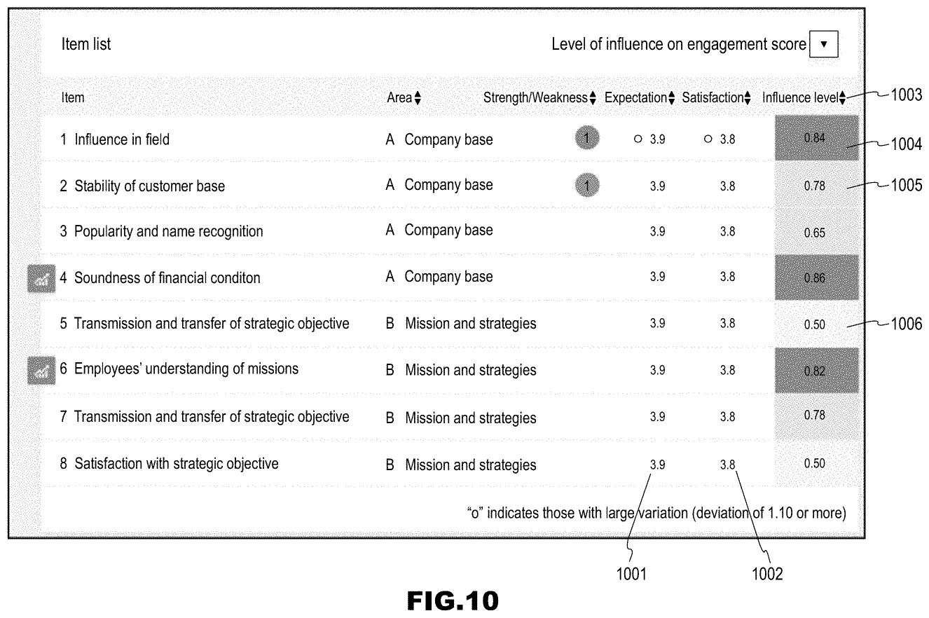

Next, the processing unit 13 configures information that is to be output, from the acquired information. Then, the output unit 14 outputs the configured information. FIG. 9 shows an output example in this example. In FIG. 9, 901 is an overall score “68.0” of A company. 902 is an item score of each overall item. In this case, the overall item is company, supervisor, job, or workplace. 903 is an item score of individual item and a level of influence. FIG. 10 shows an enlarged region of 903. In FIG. 10, 1001 is an average value of the expectation level information of an individual item. 1002 is an average value of the satisfaction level information of an individual item. The column 1003 indicates the level of influence of each individual item. As can be seen from 1004 to 1006 in FIG. 10, the influence level output unit 143 outputs the level of influence, in association with each item, such that the classification of the level of influence can be visually seen. That is to say, in this case, the output is performed such that the classification of the level of influence can be visually seen, for example, by setting the background in the darkest color if the level of influence is 0.8 or more, in a color with normal darkness if the level of influence is 0.6 or more and less than 0.8, and in a light color if the level of influence is less than 0.6. It will be appreciated that the method for performing output such that the classification of the level of influence can be visually seen is not limited to that with changes in the background color, and may be those with changes in various attribute values such as font, size, or the like.

As described above, according to this embodiment, it is possible to understand items that are important for an organization, with ease.

Furthermore, according to this embodiment, it is possible to acquire a level of influence of each attribute value of an organization, and to precisely understand important items.

Furthermore, according to this embodiment, it is possible to provide an information processing apparatus 1 that can acquire engagement scores and can be used as a so-called engagement apparatus.

According to the specific example of this embodiment, a level of influence is acquired for each attribute value of an organization. Note that it is also possible that a level of influence of each item is acquired regardless of an attribute value of an organization. The technique for acquiring a level of influence for each attribute value of an organization is a technique focusing on an aspect that properties of companies are different according to attribute values of organizations. This technique is extremely useful, for example, for engagement in which employees and an organization grow due to the employees trying to display their abilities on their own judgment in order to achieve a goal of the organization.

The processing in this embodiment may be realized by software. The software may be distributed by software downloads or the like. Furthermore, the software may be distributed in a form where the software is stored in a storage medium such as a CD-ROM. Note that the same is applied to other embodiments described in this specification. The software that realizes the information processing apparatus 1 in this embodiment is the following sort of program. Specifically, this program is, for example, a program for causing a computer capable of accessing a storage medium including an organization response information storage unit in which organization response information is stored for two or more organizations, the information containing, for each of two or more members belonging to the organizations, two or more pieces of item response information having an item identifier for identifying an item regarding an organization, and response information containing satisfaction level information, which is a response regarding a satisfaction level of a member to the item, to function as: an item score acquiring unit that performs statistical processing on the response information of the members to the two or more items contained in the two or more pieces of organization response information, thereby acquiring an item score, which is a score for an item, for each organization and for each item; an overall score acquiring unit that acquires an overall score, which is an overall score for each organization, using the two or more item scores from the two or more pieces of organization response information; an influence level acquiring unit that acquires, for each item, an level of influence of item scores of the item on overall scores, using the item scores of the two or more items of the two or more organizations and the overall scores of the two or more organization; and an influence level output unit that outputs the level of influence acquired by the influence level acquiring unit, in association with each item. This program may also be said to be a program for realizing an engagement system.

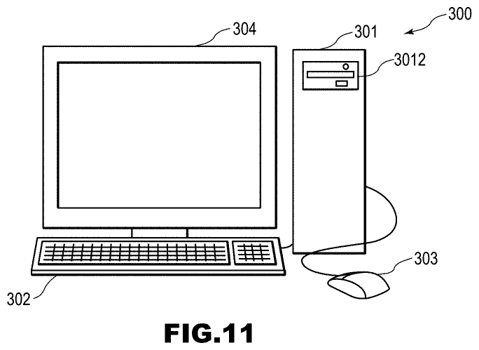

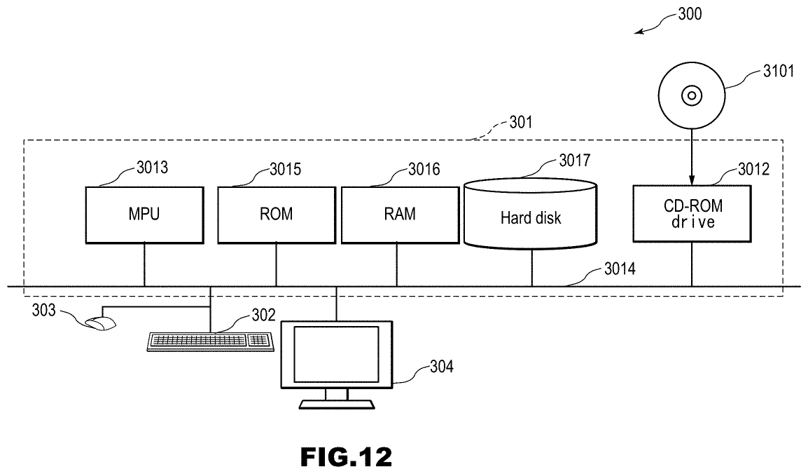

FIG. 11 shows the external appearance of a computer that executes the program described in this specification to realize the information processing apparatus 1 and the like in the foregoing various embodiments. The foregoing embodiments may be realized using computer hardware and a computer program executed thereon. FIG. 11 is a schematic view of a computer system 300. FIG. 12 is a block diagram of the system 300. FIGS. 11 and 12 show the external appearance and the like of a computer that realizes the engagement system.

In FIG. 11, the computer system 300 includes a computer 301 including a CD-ROM drive 3012, a keyboard 302, a mouse 303, and a monitor 304.

In FIG. 12, the computer 301 includes, in addition to the CD-ROM drive 3012, an MPU 3013, a bus 3014 connected to the CD-ROM drive 3012 and the like, a ROM 3015 in which a program such as a boot up program is stored, a RAM 3016 that is connected to the MPU 3013 and is a memory in which a command of an application program is temporarily stored and a temporary storage area is provided, and a hard disk 3017 in which an application program, a system program, and data are stored. Although not shown, the computer 301 may further include a network card that provides connection to a LAN.

The program for causing the computer system 300 to execute the functions of the information processing apparatus 1 and the like in the foregoing embodiments may be stored in a CD-ROM 3101 that is inserted into the CD-ROM drive 3012, and be transmitted to the hard disk 3017. Alternatively, the program may be transmitted via a network (not shown) to the computer 301 and stored in the hard disk 3017. At the time of execution, the program is loaded into the RAM 3016. The program may be loaded from the CD-ROM 3101, or directly from a network.

The program does not necessarily have to include, for example, an operating system (OS) or a third party program to cause the computer 301 to execute the functions of the information processing apparatus 1 and the like in the foregoing embodiments. The program may only include a command portion to call an appropriate function (module) in a controlled mode and obtain desired results. The manner in which the computer system 300 operates is well known, and thus a detailed description thereof has been omitted.

It should be noted that, in the program, in a step of transmitting information, a step of receiving information, or the like, processing that is performed by hardware, for example, processing performed by a modem or an interface card in the transmitting step (processing that can be performed only by hardware) is not included.

Furthermore, the computer that executes the program may be a single computer, or may be multiple computers. That is to say, centralized processing may be performed, or distributed processing may be performed.

Furthermore, in the foregoing embodiments, it will be appreciated that two or more communication parts in one apparatus may be physically realized by one medium.

In the foregoing embodiments, each process may be realized as centralized processing using a single apparatus, or may be realized as distributed processing using multiple apparatuses. That is to say, the information processing apparatus 1 may be a stand-alone apparatus. If the information processing apparatus 1 is a stand-alone apparatus, the accepting unit 12 accepts instructions, information, or the like from users or the like. The output unit 14 outputs information and the like through displaying, sound output, or transmission to a display apparatus.

The present invention is not limited to the embodiment set forth herein. Various modifications are possible within the scope of the present invention.

### INDUSTRIAL APPLICABILITY

As described above, the information processing apparatus according to the present invention has the effect of making it possible to understand important items with ease from the viewpoint of an organization, and thus this apparatus is useful as the above-described server apparatus and the like for realizing engagement.

1. An information processing apparatus comprising:
an organization response information storage unit in which organization response information is stored for two or more organizations, the information containing, for each of two or more members belonging to the organizations, two or more pieces of item response information having an item identifier for identifying an item regarding an organization, and response information containing satisfaction level information, which is a response regarding a satisfaction level of a member to the item;
an item score acquiring unit that performs statistical processing on the response information of the members to the two or more items contained in the two or more pieces of organization response information, thereby acquiring an item score, which is a score for an item, for each organization and for each item;
an overall score acquiring unit that acquires an overall score, which is an overall score for each organization, using the two or more item scores from the two or more pieces of organization response information;
an influence level acquiring unit that acquires, for each item, an level of influence of item scores of the item on overall scores, using the item scores of the two or more items of the two or more organizations and the overall scores of the two or more organization; and
an influence level output unit that outputs the level of influence acquired by the influence level acquiring unit, in association with each item.

2. The information processing apparatus according to claim 1,
wherein, for at least some of the items, the response information also contains expectation level information, which is a response regarding an expectation level of a member, and
the item score acquiring unit acquires, for each organization, item scores of at least some of the items, using the satisfaction level information and the expectation level information.

3. The information processing apparatus according to claim 2,
wherein the overall score acquiring unit acquires a tentative overall score, which is a tentative overall score for each organization, using the two or more item scores from the two or more pieces of organization response information, acquires correlation information regarding a degree of correlation between the satisfaction level information and the expectation level information of each of the two or more items, for each of the two or more organizations, and acquires an overall score from the tentative overall score using the correlation information such that the larger the degree of correlation is, the larger the score is.

4. The information processing apparatus according to claim 1,
wherein, for each of the two or more organizations, the item score acquiring unit calculates, for each of the two or more items, an average value of the satisfaction level information contained in the response information, or an average value of the satisfaction level information contained in the response information and an average value of the expectation level information contained in the response information, and acquires an item score for each item using the one or two average values.

5. The information processing apparatus according to claim 1,
wherein the two or more items have multiple overall items that are each an item for an overall object and multiple individual items that are each an item for an individual object of a company, and
the overall score acquiring unit acquires an overall score, using both item scores of the overall items and item scores of the individual items while making weights of the item scores of the overall items greater than those of the item scores of the individual items.

6. The information processing apparatus according to claim 1,
wherein the influence level acquiring unit calculates, for each item, a level of influence, which is information regarding correlation between item scores of the item and overall scores, using the overall scores of the two or more organizations and the item scores of the item of the two or more organizations.

7. The information processing apparatus according to claim 1,
wherein the organization response information is associated with an attribute value of an organization, and
the influence level acquiring unit acquires, for each item, an level of influence of item scores of the item on overall scores, for each attribute value of an organization.

8. The information processing apparatus according to claim 1,
wherein the level of influence is classified into two or more levels, and
the influence level output unit outputs the level of influence, in association with each item, such that the classification of the level of influence can be visually seen.

9. An information processing method realized using an organization response information storage unit in which organization response information is stored for two or more organizations, the information containing, for each of two or more members belonging to the organizations, two or more pieces of item response information having an item identifier for identifying an item regarding an organization, and response information containing satisfaction level information, which is a response regarding a satisfaction level of a member to the item, an item score acquiring unit, an overall score acquiring unit, an influence level acquiring unit, and an influence level output unit, comprising:
an item score acquiring step of the item score acquiring unit performing statistical processing on the response information of the members to the two or more items contained in the two or more pieces of organization response information, thereby acquiring an item score, which is a score for an item, for each organization and for each item;
an overall score acquiring step of the overall score acquiring unit acquiring an overall score, which is an overall score for each organization, using the two or more item scores from the two or more pieces of organization response information;
an influence level acquiring step of the influence level acquiring unit acquiring, for each item, an level of influence of item scores of the item on overall scores, using the item scores of the two or more items of the two or more organizations and the overall scores of the two or more organization; and
an influence level output step of the influence level output unit outputting the level of influence acquired in the influence level acquiring step, in association with each item.

10. A storage medium on which a program is stored, the program causing a computer capable of accessing a storage medium including an organization response information storage unit in which organization response information is stored for two or more organizations, the information containing, for each of two or more members belonging to the organizations, two or more pieces of item response information having an item identifier for identifying an item regarding an organization, and response information containing satisfaction level information, which is a response regarding a satisfaction level of a member to the item, to function as:
an item score acquiring unit that performs statistical processing on the response information of the members to the two or more items contained in the two or more pieces of organization response information, thereby acquiring an item score, which is a score for an item, for each organization and for each item;
an overall score acquiring unit that acquires an overall score, which is an overall score for each organization, using the two or more item scores from the two or more pieces of organization response information;
an influence level acquiring unit that acquires, for each item, an level of influence of item scores of the item on overall scores, using the item scores of the two or more items of the two or more organizations and the overall scores of the two or more organization; and
an influence level output unit that outputs the level of influence acquired by the influence level acquiring unit, in association with each item.
